(19) United States
(12) Patent Application Publication
(10) Pub. No.: US 2025/0304147 A1
(43) Pub. Date: Oct. 2, 2025

(54) VEHICLE STEERING DEVICE AND VEHICLE INCLUDING THE SAME

(71) Applicant: HL MANDO CORPORATION, Gyeonggi-do (KR)

(72) Inventor: Kyeong Ho LEE, Gyeonggi-do (KR)

(21) Appl. No.: 19/019,455

(22) Filed: Jan. 13, 2025

(30) Foreign Application Priority Data
Apr. 1, 2024 (KR) 10-2024-0043998

(51) Int. Cl. B62D 5/04

(52) U.S. Cl. CPC B62D 5/046; B62D 5/0409; B62D 5/0421

(57) ABSTRACT

A vehicle steering device or a vehicle comprises an upper tube in which a steering shaft is rotatably coupled, a lower tube having the upper tube inserted therein and having a through-hole penetrating an outer circumferential surface and inner circumferential surface thereof, and a tube support coupled to the through-hole and radially supporting the upper tube.

### CROSS-REFERENCE TO RELATED APPLICATION

This application claims priority from Korean Patent Application No. 10-2024-0043998, filed on Apr. 1, 2024, which is hereby incorporated by reference for all purposes as if fully set forth herein.

### BACKGROUND

### Field

The present embodiments relate to a vehicle steering device and a vehicle including the same.

### Description of Related Art

Typically, a vehicle steering device is installed on a front side inside the driver's seat to be able to deliver the steering force generated from the steering wheel to the wheels through the gear box and includes telescoping and tilting features to be able to adjust the position of the steering wheel depending on the driver's physical condition.

By the telescoping and tilting features, the driver may adjust the protrusion and tilt angle of the steering wheel to fit his height or body shape to enable smooth steering.

However, the conventional vehicle steering device may cause noise and vibration due to an increase in friction between the upper tube and the lower tub when telescoping operates, and the shakes of the steering wheel due to a movement at a predetermined angle from the telescoping direction makes the driver feel uncomfortable.

Therefore, a need arises for research on a vehicle steering device capable of suppressing vibration and noise during telescoping and enhancing the sense of telescoping that the driver feels, and a vehicle including the same.

### BRIEF SUMMARY

Conceived in the foregoing background, the present embodiments relate to a vehicle steering device and a vehicle capable of preventing a movement at a predetermined angle from the telescoping direction when the driver operates telescoping and making the frictional force uniform, thereby suppressing noise and vibration and enhancing the sense of telescoping that the driver feels.

According to the present embodiments, there may be provided a vehicle steering device, comprising an upper tube to which a steering shaft is rotatably coupled, a lower tube in which at least a portion of the upper tube is movably inserted, the lower tube having at least one through-hole, and a tube support coupled to the at least one through-hole of the lower tube and radially supporting the upper tube.

According to the present embodiments, there may be provide a vehicle, comprising a steering shaft connected to a steering wheel, an upper tube in which the steering shaft is rotatably coupled, a lower tube having the upper tube inserted therein and having a through-hole penetrating an outer circumferential surface and inner circumferential surface thereof, a tube support coupled to the through-hole and radially supporting the upper tube, a torque sensor coupled to a side of the steering shaft to detect and transmit a torque of the steering shaft, and a controller receiving information transmitted from the torque sensor and transmitting a control signal to a rack driving member.

According to the present embodiments, as described above, it is possible to prevent a movement at a predetermined angle from the telescoping direction when the driver operates telescoping and make the frictional force uniform, thereby suppressing noise and vibration and enhancing the sense of telescoping that the driver feels.

### DESCRIPTION OF DRAWINGS

The above and other objects, features, and advantages of the disclosure will be more clearly understood from the following detailed description, taken in conjunction with the accompanying drawings, in which:

FIGS. 1 and 2 are perspective views illustrating a portion of a vehicle steering device according to the present embodiments;

FIG. 3 is an exploded perspective view illustrating a portion of a vehicle steering device according to the present embodiments;

FIGS. 4 to 6 are perspective views illustrating a portion of a vehicle steering device according to the present embodiments;

FIG. 7 is an exploded perspective view illustrating a portion of a vehicle steering device according to the present embodiments;

FIGS. 8 and 9 are cross-sectional views illustrating a portion of a vehicle steering device according to the present embodiments; and

FIG. 10 is a view schematically illustrating a vehicle according to the present embodiments.

### DETAILED DESCRIPTION

In the following description of examples or embodiments of the disclosure, reference will be made to the accompanying drawings in which it is shown by way of illustration specific examples or embodiments that can be implemented, and in which the same reference numerals and signs can be used to designate the same or like components even when they are shown in different accompanying drawings from one another. Further, in the following description of examples or embodiments of the disclosure, detailed descriptions of well-known functions and components incorporated herein will be omitted when it is determined that the description may make the subject matter in some embodiments of the disclosure rather unclear. The terms such as “including”, “having”, “containing”, “constituting” “make up of”, and “formed of” used herein are generally intended to allow other components to be added unless the terms are used with the term “only”. As used herein, singular forms are intended to include plural forms unless the context clearly indicates otherwise.

Terms, such as “first”, “second”, “A”, “B”, “(A)”, or “(B)” may be used herein to describe elements of the disclosure. Each of these terms is not used to define essence, order, sequence, or number of elements etc., but is used merely to distinguish the corresponding element from other elements.

When it is mentioned that a first element “is connected or coupled to”, “contacts or overlaps” etc. a second element, it should be interpreted that, not only can the first element “be directly connected or coupled to” or “directly contact or overlap” the second element, but a third element can also be “interposed” between the first and second elements, or the first and second elements can “be connected or coupled to”, “contact or overlap”, etc. each other via a fourth element. Here, the second element may be included in at least one of two or more elements that “are connected or coupled to”, “contact or overlap”, etc. each other.

When time relative terms, such as “after,” “subsequent to,” “next,” “before,” and the like, are used to describe processes or operations of elements or configurations, or flows or steps in operating, processing, manufacturing methods, these terms may be used to describe non-consecutive or non-sequential processes or operations unless the term “directly” or “immediately” is used together.

In addition, when any dimensions, relative sizes etc. are mentioned, it should be considered that numerical values for an elements or features, or corresponding information (e.g., level, range, etc.) include a tolerance or error range that may be caused by various factors (e.g., process factors, internal or external impact, noise, etc.) even when a relevant description is not specified. Further, the term “may” fully encompasses all the meanings of the term “can”.

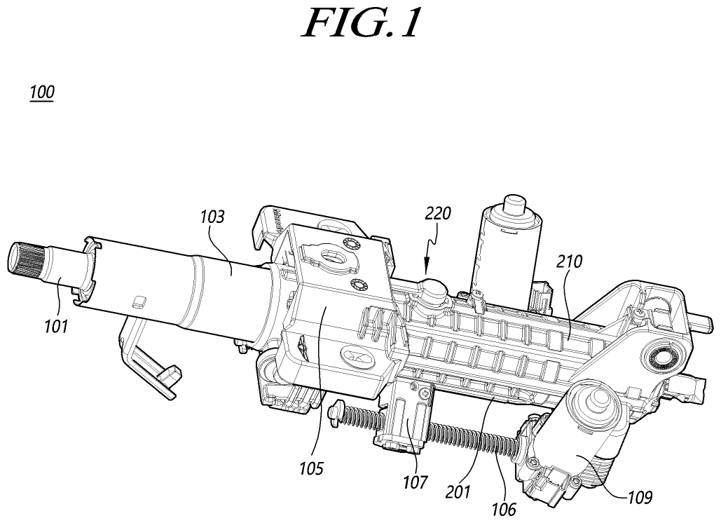

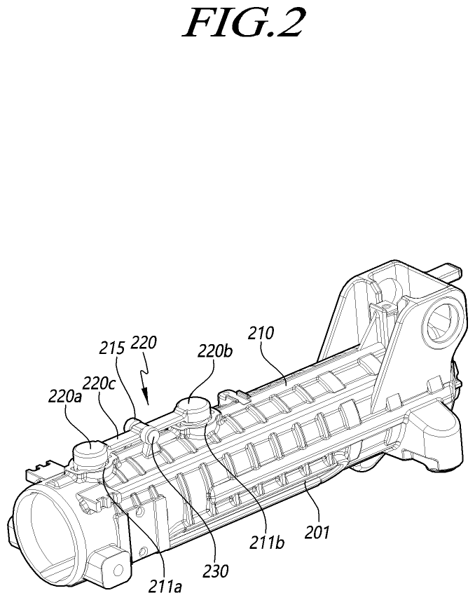

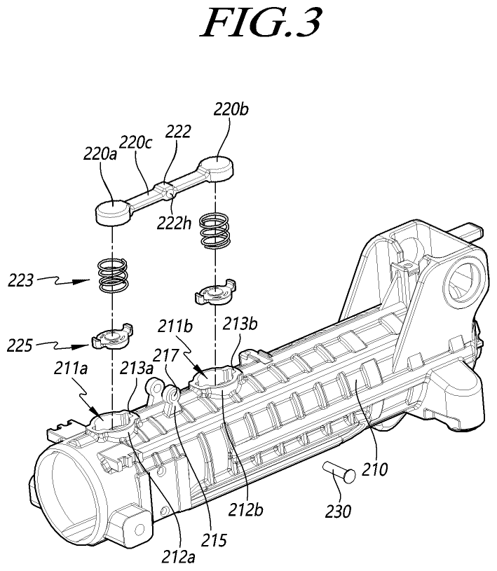

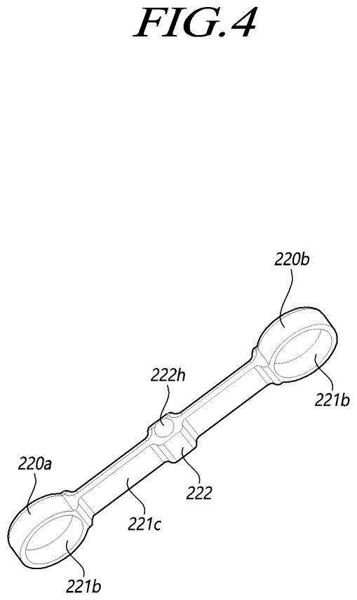

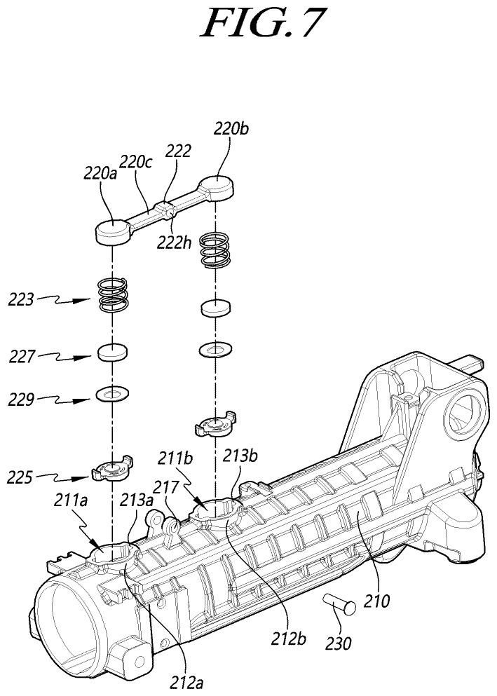

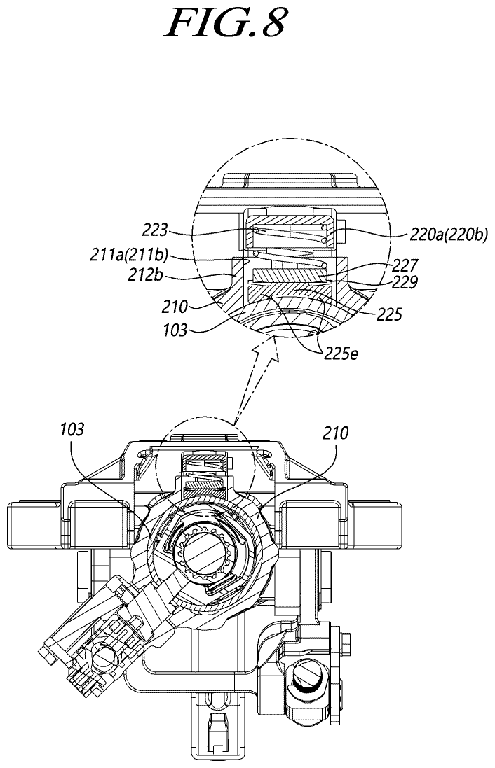

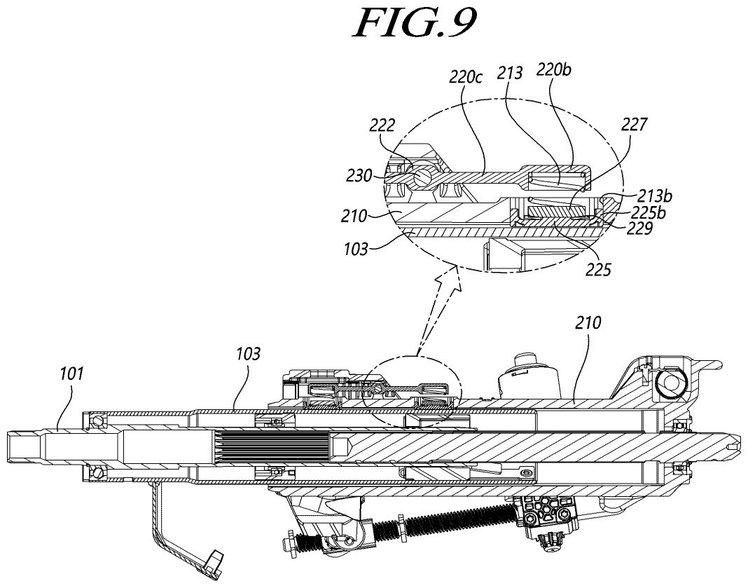

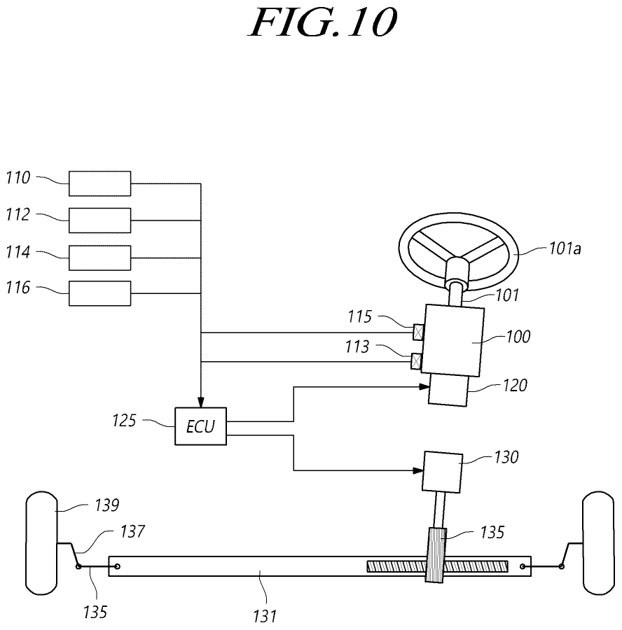

FIGS. 1 and 2 are perspective views illustrating a portion of a vehicle steering device according to the present embodiments. FIG. 3 is an exploded perspective view illustrating a portion of a vehicle steering device according to the present embodiments. FIGS. 4 to 6 are perspective views illustrating a portion of a vehicle steering device according to the present embodiments. FIG. 7 is an exploded perspective view illustrating a portion of a vehicle steering device according to the present embodiments. FIGS. 8 and 9 are cross-sectional views illustrating a portion of a vehicle steering device according to the present embodiments. FIG. 10 is a view schematically illustrating a vehicle according to the present embodiments.

The foldable steering wheel assembly 100 is described below with reference to FIGS. 1 to 6.

According to the present embodiments, there may be provided a vehicle steering device 100 including an upper tube 103 to which a steering shaft 101 is rotatably coupled, a lower tube 210 in which at least a portion of the upper tube 103 is movably inserted, the lower tube 210 having at least one through-hole 211a and 211b, and a tube support 220 coupled to the at least one through-hole 211a and 211b of the lower tube 210 and radially supporting the upper tube 103.

First, referring to FIG. 1, a vehicle steering device 100 according to the present embodiments includes a steering shaft 101, an upper tube 103, a lower tube 210, a mounting bracket 105, a telescope motor 109, a telescope screw 106, a telescope nut 107, or the like.

The steering shaft 101 is coupled to the steering wheel (not shown) manipulated by the driver and rotates together to transfer steering force.

The steering shaft 101 101 is rotatably supported and coupled inside the upper tube 103 formed in a hollow shape.

The upper tube 103 is inserted and coupled into an end portion of the lower tube 210 to perform axial telescope motion, and a mounting bracket 105 for fixing the steering column to the vehicle body is coupled to the outer side of the lower tube 210.

Referring to FIGS. 1 and 2, in the steering device according to the present embodiments, the tube support 220 is rotatably supported by the lower tube 210 and coupled to the at least one through-hole to radially support the outer circumferential surface of the upper tube 103 so that the frictional force between the upper tube 103 and the lower tube 210 remains constant and no movement is made during telescoping by the driver.

The at least one through-hole of the lower tube 210 comprises a pair of through-holes 211a and 211b axially spaced apart from each other, and the tube support 220 is coupled to the pair of through-holes 211a and 211b of the lower tube 210 to support one axial side portion and another axial side portion of the upper tube 103. In other words, the lower tube 210 has a pair of through-holes 211a and 211b axially spaced apart from each other to penetrate the outer circumferential surface and inner circumferential surface at the end portion where the upper tube 103 is inserted.

The tube support 220 may be coupled to each of the through-holes 211a and 211b axially spaced apart to support one side and the other side of the upper tube 103 in the axial direction.

The tube support 220 may include a first tube support portion 220a and a second tube support portion 220b coupled to the through-holes 211a and 211b, respectively, to support the upper tube 103, and a connection portion 220c connecting the first tube support portion 220a and the second tube support portion 220b.

A central portion of the connection portion 220c is rotatably coupled to the lower tube 210, and the lower tube 210 is provided with a rotation support portion 215 for supporting rotation of the connection portion 220c.

In other words, as illustrated in FIG. 3, a hinge portion 222 having a hinge hole 222h is provided in a central portion of the connection portion 220c, and a support hole 217 communicating with the hinge hole 222h is formed in the rotation support portion 215 of the lower tube 210.

Further, the hinge shaft 230 is coupled to the hinge hole 222h and the support hole 217 to enable the tube support 220 to rotate about the hinge shaft 230.

Further, as illustrated in FIG. 3, the tube support 220 may further include elastic parts 223 supported on the first tube support portion 220a and the second tube support portion 220b, and a contact parts 225 supported on the elastic parts 223 and disposed in the pair of through-holes 211a and 211b of the lower tube 210 to support the outer circumferential surface of the upper tube 103.

Here, the elastic parts 223 is illustrated as an example of a coil spring, but is not necessarily limited thereto, and any component that generates an elastic force in both the upper and lower directions between the first tube support portion 220a and the contact parts 225 and between the second tube support portion 220b and the contact parts 225 may be possible.

Referring to FIG. 4, the tube support 220 may include insertion recesses 221b. Insertion recesses 221b provided at the first tube support portion 220a and the second tube support portion 220b, and ends of the elastic parts 223 are inserted into the insertion recesses.

Accordingly, when the tube support 220 is assembled and operated, the elastic parts 223 does not deviate from the first tube support portion 220a and the second tube support portion 220b and generates an elastic force at the correct position.

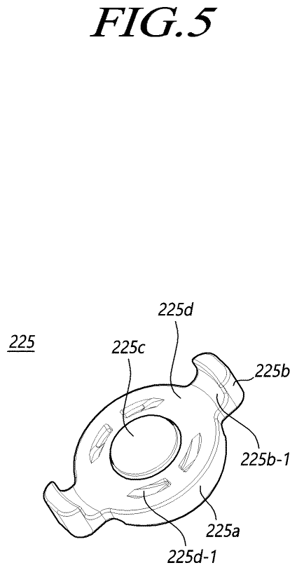

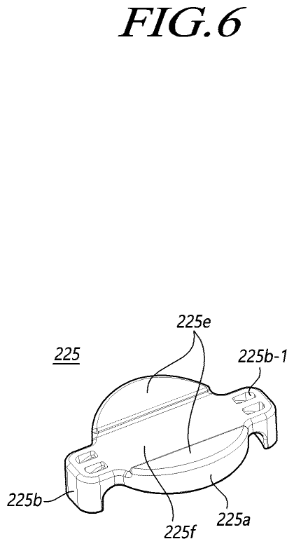

Referring to FIGS. 5 and 6, one of the contact parts 225 may include a main body 225a having one surface supporting one end of one of the elastic parts 223 and another surface supporting the outer circumferential surface of the upper tube 103, and an extension support portion 225b extending radially from a side surface of the main body 225a.

According to an embodiment, the contact parts 225 may be formed of an engineering plastic material, and for example, the contact parts 225 may be formed of polyacetal.

A support surface 225d having a flat or curved shape is formed on the upper surface of the main body 225a so that one end of the elastic parts 223 is uniformly supported, and one or more cuts 225d-1 are provided to minimize deformation of the shape and reduce weight during manufacturing.

The inner circumferential surfaces of the through-holes 211a and 211b of the lower tube 210 are provided with seating recesses 213a and 213b to which the extension support portion 225b of the contact parts 225 is inserted.

Accordingly, when the telescope is operated, the extension support portion 225b of the contact parts 225 may be supported on the seating recesses 213a and 213b to support the upper tube 103 at the correct position without rotating.

Further, since the support surface 225d of the main body 225a and the connection portion 225b-1 of the extension support portion 225b are formed as curved surfaces, rigidity is maintained so that damage or deformation of the extension support portion 225b does not occur even when an external force for rotating the contact parts 225 is transferred during driving of the vehicle or during telescoping.

Meanwhile, as illustrated in FIG. 6, a spacing recess 225f spaced apart from the outer circumferential surface of the upper tube 103 and disposed toward the steering shaft 101 may be provided in the center of the lower surface of one of the contact parts 225.

Accordingly, due to the spacing recess 225f, excessive frictional force between the contact parts 225 and the upper tube 103 may be reduced, and noise and vibration may be reduced.

Further, two opposite sides of the spacing recess 225f may be provided with inclined surfaces 225e supported by the outer circumferential surface of the upper tube 103.

Accordingly, the inclined surfaces 225e supports the outer circumferential surface of the upper tube 103 on two opposite sides in the radial direction with respect to the spacing recess 225f, so that the supporting force of the contact parts 225 may be maintained uniformly.

Referring to FIGS. 7 to 9 together with FIGS. 4 to 6, the tube support 220 may further include an insertion member 227 disposed between one of the elastic parts 223 and one of the contact parts 225 to transfer the supporting force the one of the elastic parts 223 to the one of the contact parts 225.

The insertion member 227 prevents the elastic parts 223 and the contact parts 225 from being fixed or jammed after the durability progresses to some extent, while damping noise and vibration generated when the elastic parts 223 is elastically deformed.

According to an embodiment, the insertion member 227 may be formed of an engineering plastic material, and for example, the insertion member 227 may be formed of polyacetal.

Here, the elastic parts 223 and the contact parts 225 are the same as those described above, and thus a detailed description thereof will be omitted.

The tube support 220 may further include an elastic support member 229 disposed between the insertion member 227 and the one of the contact parts 225 to elastically support the insertion member 227 toward the elastic parts 223.

Therefore, after the durability is somewhat progressed, the elastic support member 229 prevents the insertion member 227 and the contact parts 225 from being fixed or jammed, while damping noise and vibration due to friction with the upper tube 103 transferred through the contact parts 225.

The elastic support member 229 is formed in a ring shape, and the connecting surface between the inner circumferential surface and the outer circumferential surface is formed as an inclined surface to be stepped toward the center axis of the through-holes 211a and 211b.

The upper surface of the contact parts 225 is provided with an insertion protrusion 225c protruding in a direction of a center axis of the through-holes 211a and 211b and inserted into the inner circumferential surface of the elastic support member 229.

Accordingly, since the inner circumferential surface of the elastic support member 229 is supported on the insertion protrusion 225c, radial movement may be prevented, and elastic deformation is performed only in the vertical direction at the correct position, thereby elastically supporting the insertion member 227.

Meanwhile, referring to FIGS. 1 to 9 together with FIG. 10, a vehicle according to the present embodiments includes a steering shaft 101 connected to a steering wheel 101a, an upper tube 103 to which the steering shaft 101 is rotatably coupled, a lower tube 210 in which at least a portion of the upper tube 103 is movably inserted, having a through-hole 211a and 211b, a tube support 220 coupled to the through-hole 211a and 211b of the lower tube 210 and radially supporting the upper tube 103, a torque sensor 115 configured to detect a torque of the steering shaft 101, and a controller 125 configured to output a control signal for controlling movement of a rack bar 131 according to the detected torque of the steering shaft.

Here, the upper tube 103, the lower tube 210, the tube support 220, or the like constitute the vehicle steering device 100, and are the same as those described above, and thus a detailed description thereof will be omitted.

As shown in FIG. 10, in the vehicle according to the present embodiments, an angle sensor 113 and a torque sensor 115 are coupled to one side of the steering shaft 101 connected with the steering wheel 101a and, when the driver manipulates the steering wheel 101, the angle sensor 113 and the torque sensor 117 detecting the manipulation send electrical signals to the controller 125 to operate a shaft motor 120 and the pinion shaft motor 130. The shaft motor 120 is coupled to an end portion of the steering shaft 101 and configured to rotate the steering shaft 101.

The controller 125 may control the shaft motor 120 and the pinion shaft motor 130 based on the electrical signals transmitted from the angle sensor 113 and the torque sensor 115 and the electrical signals transmitted from other various sensors mounted on the vehicle, and the steering shaft motor 120 may be provided with a reducer for reducing the number of revolutions of the motor.

The pinion shaft motor 130 may slide the rack bar 131 connected to the pinion shaft 135 to perform steering of two opposite wheels 139 through the tie rods 135 and the knuckle arms 137, and the steering shaft motor 120 may generate a steering reaction sense in the opposite direction when the steering wheel 101a is manipulated by the driver or may perform steering of the steering shaft 101 during autonomous driving.

FIG. 10 illustrates an example in which there is provided a steer-by-wire steering device in which the steering shaft 101 and the pinion shaft 135 are electrically connected via the controller 125, but the present embodiments may also be applied to the conventional steering device in which the steering shaft 101 and the pinion shaft 135 are connected via a mechanical component, such as a universal joint and an intermediate shaft.

In addition to the angle sensor 113 and the torque sensor 115 provided on the steering shaft 101, a motor position sensor 110 for transmitting steering information to the controller 125, various radars 112 and lidars 114, a camera image sensor 116, or the like may be provided in the present embodiments, and a detailed description thereof will be omitted below.

According to the present embodiments having the above-described shape and structure, it is possible to prevent a movement at a predetermined angle from the telescoping direction when the driver operates telescoping and make the frictional force uniform, thereby suppressing noise and vibration and enhancing the sense of telescoping that the driver feels.

The above description has been presented to enable any person skilled in the art to make and use the technical idea of the disclosure, and has been provided in the context of a particular application and its requirements. Various modifications, additions and substitutions to the described embodiments will be readily apparent to those skilled in the art, and the general principles defined herein may be applied to other embodiments and applications without departing from the spirit and scope of the disclosure. The above description and the accompanying drawings provide an example of the technical idea of the disclosure for illustrative purposes only. That is, the disclosed embodiments are intended to illustrate the scope of the technical idea of the disclosure. Thus, the scope of the disclosure is not limited to the embodiments shown, but is to be accorded the widest scope consistent with the claims.

What is claimed:

1. A vehicle steering device comprising:
an upper tube to which a steering shaft is rotatably coupled;
a lower tube in which at least a portion of the upper tube is movably inserted, the lower tube having at least one through-hole; and
a tube support coupled to the at least one through-hole of the lower tube and radially supporting the upper tube.

2. The vehicle steering device of claim 1, wherein the at least one through-hole of the lower tube comprises a pair of through-holes axially spaced apart from each other, and the tube support is coupled to the pair of through-holes of the lower tube to support one axial side portion and another axial side portion of the upper tube.

3. The vehicle steering device of claim 2, wherein the tube support includes:
a first tube support portion and a second tube support portion coupled to the pair of through-holes of the lower tube, respectively, to support the upper tube; and
a connection portion connecting the first tube support portion and the second tube support portion.

4. The vehicle steering device of claim 3, wherein the connection portion of the tube support is rotatably coupled to the lower tube, and the lower tube has a rotational support portion supporting rotation of the connection portion.

5. The vehicle steering device of claim 4, wherein the connection portion of the tube support has a hinge portion having a hinge hole, the rotational support portion of the lower tube has a support hole, a hinge shaft is coupled to the hinge hole of the connection portion of the tube support and the support hole of the lower tube.

6. The vehicle steering device of claim 3, wherein the tube support includes:
elastic parts supported by the first tube support portion and the second tube support portion; and
contact parts supported by the elastic parts and disposed in the pair of through-holes of the lower tube to support an outer circumferential surface of the upper tube.

7. The vehicle steering device of claim 6, wherein the tube support includes insertion recesses provided at the first tube support portion and the second tube support portion, wherein ends of the elastic parts are inserted into the insertion recesses.

8. The vehicle steering device of claim 6, wherein one of the contact parts of the tube support includes:
a main body having one surface supporting one end of one of the elastic parts and another surface supporting the outer circumferential surface of the upper tube; and
an extension support portion radially extending from a side surface of the main body.

9. The vehicle steering device of claim 8, wherein a seating recess to which the extension support portion of the one of the contact parts of the tube support is inserted is provided on an inner circumferential surface of the lower tube.

10. The vehicle steering device of claim 6, wherein a spacing recess spaced apart from the outer circumferential surface of the upper tube is provided on a surface of one of the contact parts of the tube support.

11. The vehicle steering device of claim 10, wherein inclined surfaces supported by the outer circumferential surface of the upper tube is provided on two opposite sides of the spacing recess of the one of the contact parts of the tube support.

12. The vehicle steering device of claim 6, wherein the tube support further includes an insertion member disposed between one of the elastic parts and one of the contact parts to transfer a supporting force of the one of the elastic parts to the one of the contact parts.

13. The vehicle steering device of claim 12, wherein the tube support further includes an elastic support member disposed between the insertion member and the one of the contact parts of the tube support to elastically support the insertion member toward the elastic parts.

14. The vehicle steering device of claim 13, wherein the elastic support member has a ring shape with an angled surface.

15. The vehicle steering device of claim 14, wherein one of the contact parts of the tube support has an insertion protrusion protruding in a direction of a center axis of the through-hole and inserted to an inner circumferential surface of the elastic support member.

16. A vehicle comprising:
a steering shaft connected to a steering wheel;
an upper tube to which the steering shaft is rotatably coupled;
a lower tube in which at least a portion of the upper tube is movably inserted, the lower tube having a through-hole;
a tube support coupled to the through-hole of the lower tube and radially supporting the upper tube;
a torque sensor configured to detect a torque of the steering shaft; and
a controller configured to output a control signal for controlling movement of a rack bar according to the detected torque of the steering shaft.

17. The vehicle of claim 16, further comprising:
a pinion shaft engaged with the rack bar; and
a pinion shaft motor configured to rotate the pinion shaft according to the control signal of the controller.

18. The vehicle of claim 17, further comprising an angle sensor configured to detect a rotation angle of the steering shaft,
wherein the controller is configured to output the control signal according to the detected rotation angle of the steering shaft.

19. The vehicle of claim 17, further comprising a shaft motor coupled to an end portion of the steering shaft and configured to rotate the steering shaft,
wherein the controller is configured to output the control signal to the shaft motor according to the detected torque of the steering shaft.

20. The vehicle of claim 19, wherein the controller is configured to output the control signal to the shaft motor and the pinion shaft motor according to the detected torque of the steering shaft and the detected rotation angle of the steering shaft.
